(19) United States
(12) Patent Application Publication
(10) Pub. No.: US 2002/0126751 A1
(43) Pub. Date: Sep. 12, 2002

(54) MAINTAINING A FRAME RATE IN A DIGITAL IMAGING SYSTEM

(76) Inventors: CHRISTOPH E. SCHEURICH, SANTA CRUZ, CA (US); SRIRAM VISVANATHAN, SAN JOSE, CA (US); OLEG B. RASHKOVSKIY, CUPERTINO, CA (US)

Correspondence Address: TIMOTHY N. TROP, REG. NO 28994, TROP , PRUNER & HU, P.C., 8554 KATY FREEWAY, STE 100, HOUSTON, TX, 77024, US

(21) Appl. No.: 09/083,601

(22) Filed: May 22, 1998

(51) Int. Cl. H04N 7/12

(52) U.S. Cl. 375/240.02; 375/240

(57) ABSTRACT

A method for communicating between a camera and a computer includes determining whether it is possible to transmit data at a requested resolution and a requested frame rate. If not, the data is transmitted at an adjusted reduced resolution (a reduced resolution, for example).

### BACKGROUND

The invention relates to maintaining a frame rate in a digital imaging system.

Digital image processing provides a way to both manipulate and analyze information in a captured digital image. In this manner, once a digital image has been captured by a digital camera, for example, the image may be enhanced and analyzed. Referring to FIG. 1, in a typical digital imaging system 10, a digital camera 12 may capture an optical image 11 and transmit a stream of data representing the image 11 to a computer 14. After the stream of data is received, the computer 14 might execute an application program 16 to cause the computer 14 to analyze and enhance the captured image. Typically, the stream of data includes frames, each of which indicates a captured image. For video, the camera 12 may transmit several frames to the computer 14, and the computer 14 may use the frames to recreate a sequence of images on a display 9.

The application program 16 may submit specific requests to regulate the manner in which the stream of data is communicated between the camera 12 and the computer 14. For example, the application program 16 may request that the frames of the stream indicate images having a specified resolution (320 horizontal pixels×240 vertical pixels, for example) and may request that the frames be transmitted at a specified frame rate. Typically, a driver program 13 causes the computer 14 to interact with the camera 12 in an attempt to satisfy these requests.

However, quite often these requests may not be accommodated due to limitations that are introduced by a communication link 15 (a serial bus, for example) that is used to transfer the stream of data from the camera 12 to the computer 14. For example, the link 15 typically has a limited bandwidth for transmitting the image data. This limitation may be caused in part by other devices using the link 15. Therefore, the bandwidth available for communicating the stream of data may be less than the maximum bandwidth of the link 15. Typically, higher resolution images require more bandwidth than lower resolution images. As a result, the available bandwidth for transmitting the stream of data may not be sufficient to sustain both the frame rate and resolution that are requested by the application program 16.

Typically, when the requests by the application program 16 cannot be accommodated, the frame rate is unintentionally decreased from the requested value to a lower frame rate due to the bandwidth limitations. This decrease in frame rate may pose problems to the application program 16, as the application program 10 may rely on a specific frame rate. For example, when a video compression mechanism that is part of the application 16 relies on specific inter-frame period, a different frame period may disrupt the compression. Additionally, with the degraded frame rate, the quality of the video may also be degraded.

As an example, a Universal Serial Bus (USB) supports a maximum device bandwidth of 12 megabits per second. To allow other devices concurrent access to the USB, the designers of the camera 12 may decide to limit a maximum USB bandwidth for the camera to 6 megabits per second. If the camera 12 transmits uncompressed pixels utilizing 8 bits per pixel, then, at a frame rate resolution of 160×120 pixels, the maximum sustainable frame rate is approximately 40 frames per second (fps). This sustainable frame rate is sufficient for typical application programs. However, if the frame resolution is increased to 320×240 pixels, the maximum sustainable frame rate drops to approximately 10 fps as described by the following equation:

$${f}_{MAX} = \frac{BC}{bHV}$$

where

f_{MAX} represents a maximum sustainable frame rate in frame rates per second,

B represents a maximum usable bandwidth (in bits per second),

C represents an average hardware compression ratio,

b represents the bits per pixel,

H represents the horizontal frame resolution (in pixels), and

V represents the vertical frame resolution (in pixels).

Thus, there is a continuing need for an imaging system that maintains the requested frame rate regardless of the available bandwidth between the camera and the computer.

### SUMMARY

The invention generally relates to maintaining a requested frame rate by adjusting a requested resolution to ensure a usable bandwidth is not exceeded.

In one embodiment, a method for communicating between a camera and a computer includes determining whether it is possible to transmit data at a requested resolution and a requested frame rate. If not, the data is transmitted at an adjusted resolution.

In another embodiment, an article includes a processor readable storage medium that stores instructions that cause a processor to determine whether it is possible to transmit data between a camera and a computer at a requested resolution and a requested frame rate. If not, the instructions cause the computer to interact with the camera to transmit the data at an adjusted resolution.

### BRIEF DESCRIPTION OF THE DRAWING

FIG. 1 is a block diagram of a digital imaging system of the prior art.

FIG. 2 is a block diagram of a digital imaging system according to an embodiment of the invention.

FIG. 3 is a flow diagram illustrating an algorithm to maintain a requested frame rate in communications over the bus of FIG. 2.

FIG. 4 is a block diagram of the camera of FIG. 2.

FIG. 5 is a block diagram of the computer of FIG. 2.

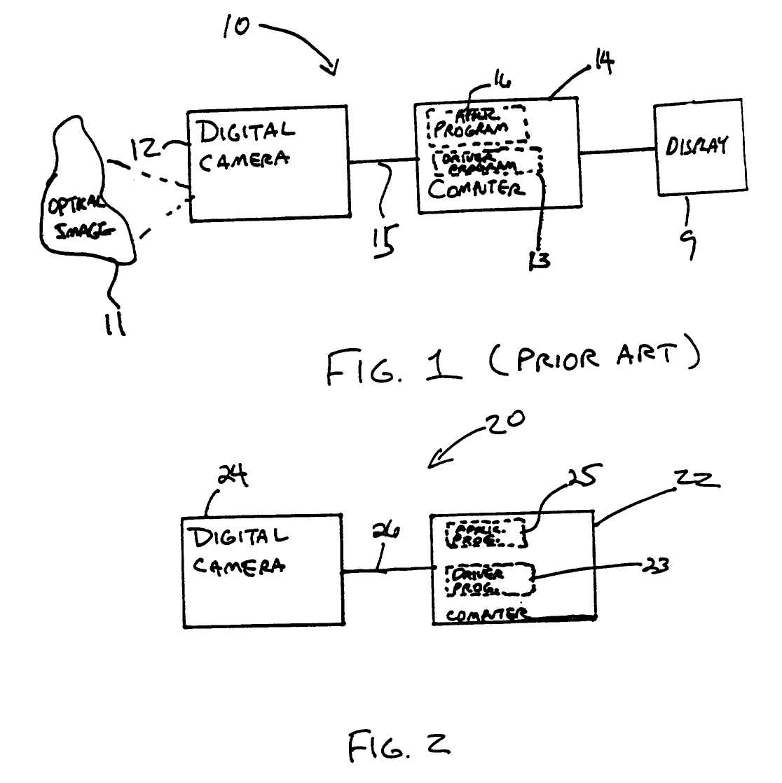

### DETAILED DESCRIPTION

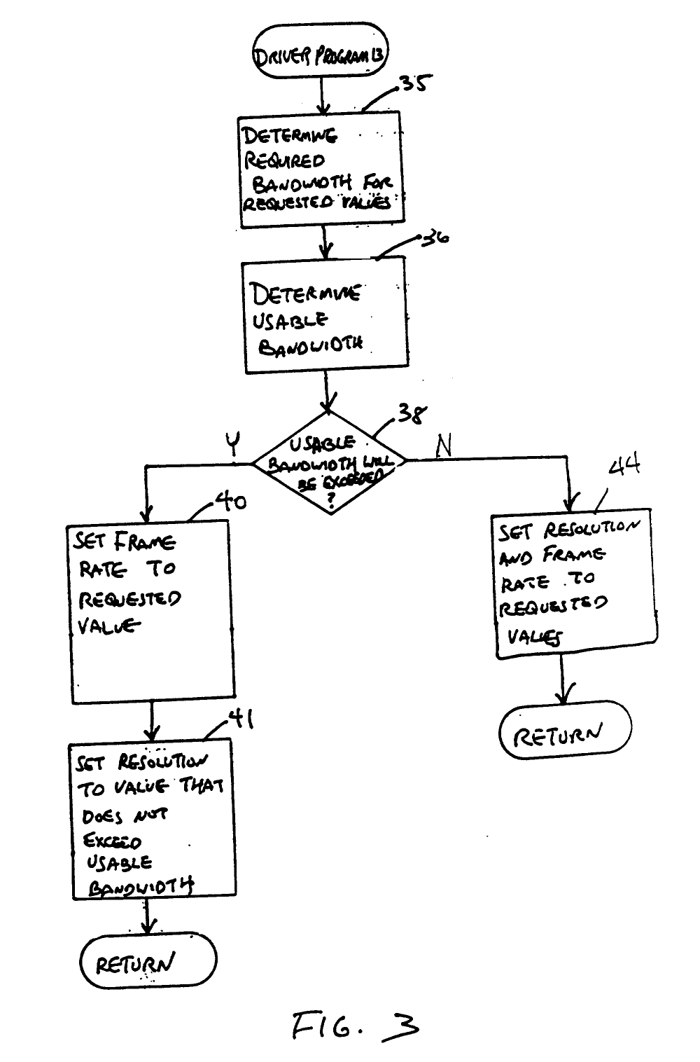

Referring to FIG. 2, an embodiment 20 of a digital imaging system in accordance with the invention includes a driver program 23 that causes a computer 22 to maintain a requested frame rate in communications between a camera 24 and the computer 22 regardless of the bandwidth that is available for the communications. In this manner, an application program 25 may, when executed by the computer 22, request a specific frame rate and a frame resolution for image data that is communicated between the camera 24 and the computer 22. If the usable bandwidth for communicating the image data does not support the requested resolution and frame rate, the driver program 23 may downwardly adjust the requested resolution to maintain the requested frame rate. In this manner, the quality (a lower resolution, for example) of the transmitted image may be traded off to maintain the requested frame rate.

However, if the available bandwidth supports these requests, the driver program 23, in some embodiments, ensures that the requested resolution and frame rate are met. For example, the available bandwidth may be 6 megabits per second. If the application program 25 requests a resolution of 160×120 at 30 frames per second (fps) or a resolution of 320×240 at 10 fps, then the driver program 23 does not need to downwardly adjust the requested resolution (see formula on p. 2). However, if the application program 25 requests a resolution of 320×240 at 30 fps, the driver program 23 may cause the camera 24 to deliver frames at a lower resolution of 180×135 while maintaining the requested frame rate of 30 fps.

To deliver the requested resolution to the application program 25, the driver program 23 may cause the computer 22 to upwardly scale the resolution of the received image data to achieve the requested resolution. For example, referring to the previous example, the driver program 23 might cause the computer 22 to upscale the received image data by 1 7/9 (after the image data is received by the computer 22) to achieve the requested resolution of 320×240.

The advantages of maintaining a requested frame rate may include one or more of the following: The resolution and frame rate capability of the camera and driver program may be fully supported. Dynamic bandwidth deficits may be accommodated. Execution of the application program may not be affected by the available bandwidth of a communication link between the computer and the camera.

In some embodiments, the bandwidths that are available are quanitized into discrete sizes. For example, if the bus 26 is a USB bus, one of the properties of the USB bus requires that data be communicated across the USB bus in the form of packets. In this manner, the image data may be transmitted across the bus 26 in the form of asynchronous packets, each of which may have one of several, discrete sizes. Therefore, if a bandwidth that satisfies the frame rate and resolution specifications may not be met with one current packet size, the driver program 23 downgrades to a smaller packet size. Thus, the available bandwidths may be quanitized.

Not only may the bandwidths be quanitized, the resolutions may also be quanitized. For example, the camera 24 may only be available to scale resolutions down by a 8:1, 4:1 or 2:1 ratio, as examples. Thus, for example, if an image captured by the camera 24 has a resolution of 640×480, the camera 24 may only be able to furnish image data (to the bus 26) that indicates an image having a resolution of 640×480, 320×240, 160×120, or 80×60. In some embodiments, the discrete sizes available for the bandwidth and resolution are taken into account by the driver program 23.

Because the usable bandwidth on the bus 26 may dynamically change, the driver routine 23 may be invoked automatically by the computer 22. For example, the driver program 23 may be invoked periodically by an interrupt request or may be invoked when a predetermined condition occurs. The driver program 23 may also be invoked, for example, when the application program 25 first requests the frame rate and resolution.

Referring to FIG. 3, in some embodiments, the driver program 23 causes the computer 22 to first determine (block 35) the required bandwidth based on the requested values for the frame rate and resolution. Next, the driver program 23 causes the computer 22 to determine (block 36) the usable bandwidth of the bus 26. This step, in some embodiments, may include a series of tests where discrete packet sizes are requested to determine the usable bandwidth. For example, the driver program 23 may cause the computer 22 to submit a request to an interface (not shown) for the bus 26 to attempt allocate a first packet size for communications across the bus 26. If the interface denies this request, then a smaller bandwidth (and packet size) is requested. This process continues until a packet size, and thus a usable bandwidth, is determined.

Once the required bandwidth is determined, the computer 22 determines (diamond 38) whether the required bandwidth exceeds the available bandwidth. If so, the computer 22 sets (block 40) the frame rate to the requested value and decreases (block 41) the resolution to a value below the requested resolution before returning from execution of the program 13. In this readjustment of the resolution, the computer 22 takes into account the scaling capabilities of the camera 24. If the required bandwidth can be accommodated, then the computer 22 sets (block 44) the frame rate and resolution equal to the requested values and returns from execution of the driver program 23.

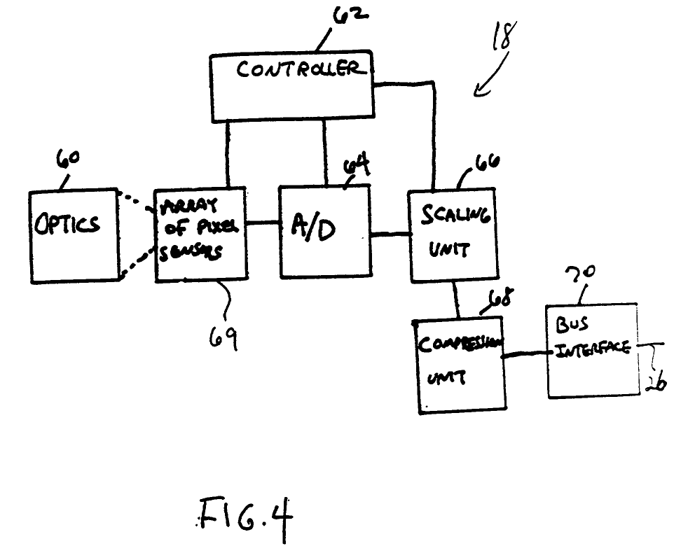

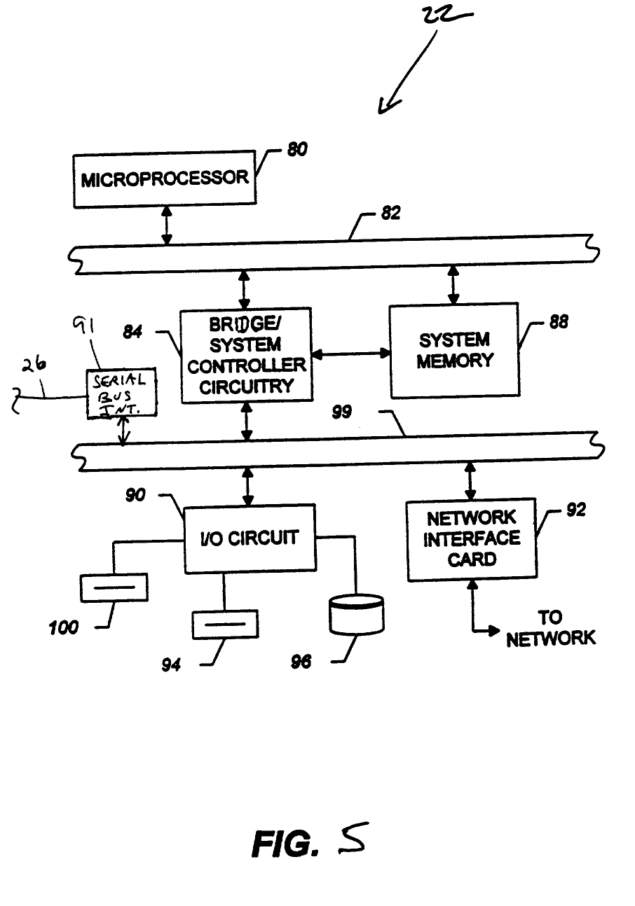

Referring to FIG. 4, the camera 24, in some embodiments, includes a controller 62 that interacts with a scaling unit 66 to scale the frames and a compression unit 68 to compress the size of the frame that is transmitted across the bus 26. The camera 24 may also include a bus interface 70 that interacts with the controller 62 to furnish the signals to the bus 26 that are representative of the frame. The camera 24 includes optics 60 that focus the optical image to be captured onto an array of pixel sensors 69 (a CMOS active pixel sensor array, for example) which electrically captures the image. An analog-to-digital (A/D) converter 64 receives analog signals from the sensors 69 and furnishes the signals to the scaling unit 66. The scaling unit 66 then passes the scaled image data to the compression unit 68 which compresses the image data and furnishes the data to the bus interface 70. The controller 62 interacts with the sensors 69 to control the exposure time of the sensors 69 to the image and the retrieval of data from the sensors 69. The controller 62 also receives the frame rate and resolution that is requested by the driver program 23 and interacts with the scaling unit 66 and the bus interface 70 to ensure that the requests by the program 23 are met.

Referring to FIG. 5, in some embodiments, the computer 22 might include a microprocessor 80 which executes a copy of the driver 23 and application 25 programs which are stored in a system memory 88. In some embodiments, the microprocessor 80 interacts with the camera 24 to communicate frames at a frame rate. Each frame indicates an image having a resolution. The driver program 23 causes the computer 22 to receive a request to set the frame rate approximately equal to a rate value and a request to set the resolution approximately equal to a first resolution value. The driver program 23 causes the computer 22 to set the frame rate approximately equal to the rate value, determine whether communication of the image data pursuant to the rate value and resolution value exceeds the available bandwidth, and based on the determination, regulate the resolution. In other embodiments, the computer system may include multiple microprocessors, and some of these microprocessors might perform the above-stated functions.

The memory 88, the microprocessor 80 and bridge/system controller circuitry 84 are all coupled to a host bus 82. The circuitry 84 also interfaces the host bus 82 to a downstream bus 99 which is coupled to an I/O controller 90, a serial bus interface 91 (to communicate with the bus 26), and a network interface card 92, as examples. The computer 10 may also have, as examples, a CD-ROM drive 100, a floppy disk drive 94 and/or a hard disk drive 96.

Other embodiments are within the scope of the following claims. For example, instead of downwardly adjusting the resolution, the resolution may be upwardly adjusted. This may occur, for example, when a requested resolution could not initially be met due to bandwidth limitations. However, if the required bandwidth subsequently becomes available, the driver program 23 may upwardly adjust the resolution.

While the invention has been disclosed with respect to a limited number of embodiments, those skilled in the art will appreciate numerous modifications and variations therefrom. It is intended that the appended claims cover all such modifications and variations as fall within the true spirit and scope of the invention.

What is claimed is:

1. A method for communicating between a camera and a computer, comprising:
determining whether it is possible to transmit data at a requested resolution and a requested frame rate; and
if not, transmitting the data at an adjusted resolution.

2. The method of claim 1, wherein the adjusted resolution comprises a decreased resolution.

3. The method of claim 1, further comprising transmitting the data at the requested frame rate.

4. The method of claim 1, wherein the act of determining comprises determining an available bandwidth for communications between the camera and the computer.

5. The method of claim 4, wherein the act of determining comprises periodically evaluating the available bandwidth.

6. The method of claim 1, wherein the act of determining comprises testing for available packet sizes for transmitting the data.

7. An article comprising a processor readable storage medium including instructions that cause a processor to:
determine whether it is possible transmit data between a camera and a computer at a requested resolution and a requested frame rate; and
if not, interact with the camera to transmit the data at an adjusted resolution.

8. The article of claim 7, wherein the adjusted resolution comprises a decreased resolution.

9. The article of claim 7, wherein the instructions to determine comprise instructions to cause the processor to transmit the data at the requested frame rate.

10. The article of claim 7, wherein the instructions to determine comprise instructions to cause the processor to determine a usable bandwidth for communications between the computer and the camera.

11. The article of claim 10, wherein the instructions to determine comprise instructions to cause the processor to periodically evaluate the available bandwidth.

12. The article of claim 7, wherein the instructions to determine comprise instructions to cause the processor to test for available packet sizes to transmit the data.

13. A computer system comprising:
a communication link;
a camera to communicate image data to the communication link; and
a computer to:
receive the image data from the communication link,
determine whether it is possible to transmit the data at a requested resolution and frame rate, and
if not, interact with the camera to transmit the data at an adjusted resolution.

14. The computer system of claim 13, wherein the adjusted resolution comprises a decreased resolution.

15. The computer system of claim 13, wherein the determination includes determining a usable bandwidth for transmissions between the camera and the computer.

16. The computer system of claim 13, wherein the determination of the usable bandwidth comprises testing for available packet sizes for transmitting the data.

17. The computer system of claim 13, wherein the computer further interacts with the computer to transmit the data at the requested frame rate.

18. The computer system of claim 13, wherein the computer further interacts with the camera to transmit the data at the requested resolution if it is possible to transmit the data at the requested resolution and the requested frame rate.
